(19) United States
(12) Patent Application Publication
(10) Pub. No.: US 2015/0301243 A1
(43) Pub. Date: Oct. 22, 2015

(54) NEAR-INFRARED ABSORPTION FILTER AND IMAGING DEVICE

(71) Applicant: SUMITOMO METAL MINING CO., LTD., Tokyo (JP)

(72) Inventors: Mika OKADA, Ichikawa-shi (JP); Atsushi TOFUKU, Ichikawa-shi (JP)

(21) Appl. No.: 14/648,799

(22) PCT Filed: Nov. 29, 2013
(86) PCT No.: PCT/JP2013/082176

§ 371 Date: Jun. 1, 2015

(30) Foreign Application Priority Data
Nov. 30, 2012 (JP) 2012-261998

(51) Int. Cl. G02B 5/20; G02B 1/02

(52) U.S. Cl. CPC G02B 5/208; G02B 5/206; G02B 1/02

(57) ABSTRACT

There is provided an imaging device capable of exhibiting high absorption to a light with a wavelength range of 700 to 1500 nm in a near-infrared region to IR region, while having high transmittance to a visible light, and an imaging device in which the infrared absorption filter is used, and is provided a near-infrared absorption filter including composite tungsten oxide particles expressed by a general formula Na_{y}WO_{z} (satisfying 0.3≦y≦1.1, 2.2≦z≦3.0), as near-infrared shielding particles.

### TECHNICAL FIELD

The present invention relates to a near-infrared absorption filter and an imaging device in which the near-infrared absorption filter is used, and specifically to a near-infrared absorption filter containing composite tungsten oxide particles, and an imaging device in which the near-infrared absorption filter is used.

### DESCRIPTION OF RELATED ART

The near-infrared absorption filter is used in the imaging device such as CCD, etc. This is because spectral sensitivity of the imaging device can be close to luminosity by shielding near-infrared rays incident on the imaging device, by using the near-infrared absorption filter. In addition, near-infrared shielding particles are contained in the near-infrared absorption filter. For example, metal complex of cyanine compounds, porphyrin compounds, indoline compounds, quinacridone compounds, perylene compounds, azo compounds, oxime or thiol, naphthoquinone compounds, diimmonium compounds, phthalocyanine compounds, and naphthalocyanine compounds, are known conventionally as the near-infrared shielding particles.

In contrast, patent document 1 discloses a near-infrared shielding body transmitting visible lights sufficiently, not having a half-mirror shaped outer appearance, not requiring a large-scale manufacturing device for film formation on a base material, and not requiring a high temperature heat treatment after film formation, and meanwhile efficiently shielding invisible near-infrared rays with a wavelength of 780 nm or more, and having transparency with no variation of color tones.

Specifically, powder of the composite tungsten oxide particles expressed by a general formula MₓW_{y}O_{z} (wherein M is an element of one kind or more selected from H, He, alkali metals, alkali earth metals, rare earth elements, Mg, Zr, Cr, Mn, Fe, Ru, Co, Rh, Ir, Ni, Pd, Pt, Cu, Ag, Au, Zn, Cd, Al, Ga, In, Tl, Si, Ge, Sn Pb, Sb, B, F, P, S, Se, Br, Te, Ti, Nb, V, Mo, Ta, Re, Be, Hf, Os, Bi, and I, W is tungsten, O is oxygen, and satisfying 0.001≦x/y≦1, 2.2≦z/y≦3.0) is fabricated by weighing and mixing a specific amount of tungsten compound, which is then heated for 1 hour at 550° C. in a reducing atmosphere as a starting raw material, and heated for 1 hour in an argon atmosphere after returning the temperature once to a room temperature, and this powder, a solvent, and a dispersant are mixed, to obtain a dispersion liquid by dispersion processing, and this dispersion liquid and a ultraviolet curing resin for hard coating are mixed, to obtain an infrared shielding material particle dispersion liquid, and this infrared shielding material particle dispersion liquid is applied, deposited, and cured on a PET resin film, to thereby obtain an infrared shielding film.

### PRIOR ART DOCUMENT

### Patent Document

Patent document 1: WO2005/037932

### SUMMARY OF THE INVENTION

### Problem to be Solved by the Invention

In recent years, there is an increasing need for a near-infrared absorption filter capable of absorbing a light in an infrared to IR region including a visible light region with a wavelength of 700 nm or more, that is, a light with a wavelength of 700 to 1800 nm. This is because performance of the infrared absorption filter can be improved by using it for the imaging device for three-dimensional images.

However, after examination by inventors of present invention, a problem is found as follows: Cyanine compounds, porphyrin compounds, indoline compounds, quinacridone compounds, perylene compounds, azo compounds, oxime or thiol metal complex, naphthoquinone compounds, diimmonium compounds, phthalocyanine compounds, and naphthalocyanine compounds don't have enough absorption to the light in the near-infrared to IR region, that is in a wavelength region of 780 to 1800 nm, irrespective of a large absorption of a visible light, and have a low light fastness.

In order to cope with the abovementioned problem, patent document 1 discloses the infrared shielding material particles capable of imparting an infrared shielding effect to window materials, etc. Specifically, patent document 1 discloses an infrared shielding body transmitting visible lights sufficiently, not having a half-mirror shaped outer appearance, not requiring a large-scale manufacturing device for film formation on a base material, and not requiring a high temperature heat treatment after film formation, and meanwhile efficiently shielding invisible near-infrared rays with a wavelength of 780 nm or more, and having transparency with no variation of color tones.

However, according to the infrared shielding film disclosed in patent document 1, there is no description regarding the shielding of the infrared rays with a wavelength of 700 to 780 nm.

In view of the above-described circumstance, the present invention is provided, and an object of the present invention is to provide a near-infrared absorption filter capable of exhibiting high absorption to a light with a wavelength range of 700 to 1500 nm in a near-infrared region to IR region, while having high transmittance to a visible light, and an imaging device in which the infrared absorption filter is used.

### Means for Solving the Problem

In order to solve the above-described problem, and as a result of strenuous efforts by inventors of the present invention, breakthrough knowledge is obtained as follows: composite tungsten oxide particles expressed by a general formula Na_{y}WO_{z} (satisfying 0.3≦y≦1.1, 2.2≦z≦3.0), have high transmittance to a visible light, and have high absorption to a light in the near-infrared to IR region, that is in a wavelength region of 700 to 1500 nm, and have an excellent ii fastness, and suitable as near-infrared shielding particles, and a near-infrared absorption filter is realized, containing the composite tungsten oxide particles as the near-infrared shielding particles. Thus, the present invention is completed.

Specifically, in order to solve the above-described problem, a first invention is a near-infrared absorption filter, including tungsten oxide composite particles expressed by a general formula Na_{y}WO_{z} (satisfying 0.3≦y≦1.1, 2.2≦z≦3.0), as near-infrared shielding particles.

A second invention is the near-infrared absorption filter of the first invention, wherein an average particle diameter of the near-infrared shielding particles is 10 nm or more and 200 nm or less.

A third invention is the near-infrared filter of the first or second invention, wherein a crystal system of the near-infrared shielding particles is cubic.

A fourth invention is a near-infrared absorption filter made of a binder resin on the transparent substrate, with the near-infrared shielding particles of any one of the first to third inventions dispersed in the binder resin, wherein any one of the UV curing resin thermosetting resin, electron beam-curable resin, cold-setting resin, and thermoplastic resin used as the binder resin.

A fifth invention is a near-infrared absorption filter on which a metal alkoxide is deposited on the transparent, substrate, with the near-infrared shielding particles of any one of the first to third inventions dispersed in the binder resin.

A sixth invention is the near-infrared absorption filter of any one of the first to fifth inventions, wherein a maximum value of the light transmittance in a wavelength range of 700 nm to 1500 nm is 5.0% or less, when the light transmittance with a wavelength of 500 nm is 45% or more.

A seventh invention is the near-infrared absorption filter of any one of the first to fifth inventions, where in a maximum value of the light transmittance in a wavelength range of 700 nm to 1500 nm is 2.5% or less, when the light transmittance with a wavelength of 500 nm is 50% or more.

An eighth invention is an imaging device, wherein the near-infrared absorption filter of any one of the first to seventh inventions is used.

### Advantage of the Invention

According to the present invention, the near-infrared absorption filter capable of exhibiting high absorption to a light with a wavelength range of 700 to 1500 nm in a near-infrared region to IR region, while having high transmittance to a visible light.

### MODES FOR CARRYING OUT THE INVENTION

Detailed explanation is given hereafter for near-infrared shielding particles, dispersants, organic solvents, near-infrared shielding particles-containing dispersion liquid containing them, and a method of producing the same, a near-infrared absorption filter containing the near-infrared shielding particles and a method of producing the same.

[1] Near-Infrared Shielding Particles-Containing Dispersion Liquid and a Method of Producing the Same

The near-infrared shielding particles-containing dispersion liquid of the present invention contains near-infrared shielding particles, dispersants, organic solvents, and further the other additive a needed.

Explanation is given hereafter for the particles, that function as the near-infrared shielding particles, dispersants, and organic solvents that constitute the near-infrared shielding particles-containing dispersion liquid, and the method of producing the particles.

(1) Near-Infrared Shielding Particles

The near-infrared shielding particles of the present invention are composite tungsten oxide particles expressed by a general formula Na_{y}WO_{z} (satisfying 0.3≦y≦1.1, 2.2≦z≦3.0). On the other hand, the composite tungsten oxide particles are the particles that significantly absorb a light in a near-infrared region, and particularly the light with a wavelength of 1000 nm or more. For example, cited document 1 discloses the matter that the composite tungsten oxide particles described herein are the particles that efficiently shield infrared rays with a wavelength of 780 nm or more, and an infrared shielding body is obtained, having transparency with no variation of color tones.

In contrast, the near-infrared shielding particles of the present invention have the characteristic of efficiently absorbing the near-infrared rays and infrared rays in a wavelength range of 700 to 1500 nm.

A mechanism of efficiently absorbing the near-infrared rays with a wavelength of 700 nm or more by the near-infrared shielding particles of the present invention, can be considered as follows.

That is, in the composite tungsten oxide particles expressed by a general formula Na_{y}WO_{z} according to the present invention, a similar mechanism as the abovementioned other tungsten oxide material, that is, absorption of the infrared rays occurs due to plasmon absorption or polaron absorption.

However, in the composite tungsten oxide particles expressed by a general formula Na_{y}WO_{z} according to the present invention, addition amount y of sodium is in a range of 0.30≦y≦1.1, preferably 0.69≦y≦1.00, and more preferably 0.69≦y≦0.78. It is found that particularly excellent absorption property can be exhibited when the addition amount y is in the vicinity of y=0.75. Although the reason is not clear, this is because a cubic crystal can be easily obtained in a single phase in the vicinity of 0.75.

It is also found that if a range of z is 2.2≦z≦3.0, preferably 2.45≦z<3.0, and more preferably 2.8≦z<3.0, excellent absorption characteristic can be exhibited. Exhibition of the infrared absorption in the composite tungsten oxide is caused by a light absorption resulting from free electrons in the near-infrared region, because the free electrons are generated in a crystal structure. Even if oxygen is present in the composite tungsten oxide at an original stoichiometric ratio, the infrared absorption is further increased, because the free electrons are further increased if oxygen defect occurs, although the infrared absorption is exhibited by the free electrons generated by Na.

If the range of z is the abovementioned range, the absorption characteristic of the present invention can be satisfied. However, if an amount of the oxygen defect is excessively large, absorption in the visible light region is also gradually increased, and therefore the value of z is preferably 2.45 or more and more preferably 2.8 or more. Also, the value of z can be suitably controlled by the producing condition, for example, by the concentration of a reducing gas or reducing time, etc.

On the other hand, the composite tungsten oxide particles expressed by Na_{y}WO_{z} are the particles that exhibit an absorption characteristic of the present invention in any one of the crystal systems of cubic, hexagonal, triclinic, tetragonal, and orthorhomobic crystal systems. However, particularly in order to obtain an excellent absorption characteristic, the cubic crystal system is preferable. As a result, supply of the free electrons by adding the sodium, is generated in the composite tungsten oxide particles, and it can be considered that the near-infrared rays are efficiently absorbed from the wavelength of 700 nm or more.

An average particle diameter of each near-infrared shielding particle can be suitably selected, depending on the purpose of use. For example, in the case of a use of emphasizing transparency, preferably the near-infrared shielding particle has the average particle diameter of 40 nm or less. This is because when the average particle diameter is smaller than 40 nm, visibility of the visible light region can be secured without completely shielding the light by scattering, and simultaneously transparency can be efficiently maintained.

(2) Method of Producing the Near-Infrared Shielding Particles

The composite tungsten oxide particles expressed by a general formula Na_{y}WO_{z} which are the near-infrared shielding particles of the present invention, can be obtained by applying heat treatment to tungsten elements or a compound of them which are raw materials, in an inert gas atmosphere or a reducing gas atmosphere.

The case of using a tungsten compound as a raw material, will be described first. One kind or more selected from any one of the tungsten trioxide powder, tungsten dioxide powder, or a hydrate of tungsten oxide, tungsten hexachloride powder, ammonium tungstate powder, or a hydrate powder of tungsten oxide obtained by dissolving the tungsten hexachloride in alcohol and drying the mixture, a hydrate powder of tungsten oxide obtained by dissolving the tungsten hexachloride in the alcohol and thereafter adding water to precipitate the tungsten hexachloride and drying the same, and a tungsten compound powder obtained by drying the ammonium tungstate aqueous solution, can be used.

When a liquid tungsten compound is used as a raw material, it is easy to uniformly mix the tungsten compound and a sodium source. Therefore, it is preferable to use an ammonium tungstate solution or a tungsten hexachloride solution as the tungsten compound.

When a tungsten element is used as the raw material, a metal tungsten powder can be used.

Next, regarding the sodium source, the salt not containing an element other than sodium, hydrogen, oxygen, and carbon, can be used as the sodium source. Specifically, one kind or more selected from sodium carbonate (hydrate), sodium carbonate (anhydrous), sodium hydrogen carbonate, sodium percarbonate, sodium oxide, sodium peroxide, sodium hydroxide, sodium acetate, and sodium citrate, can be used.

The abovementioned tungsten compound and the sodium source are respectively weighed, mixed, and pulverized into a prescribed (Na/W (molar ratio)). Mixture/pulverization of the weighed tungsten compound and the sodium source, is performed by adding water into weighed Na₂CO₃.H₂O and H₂WO₄, and mixing them by a mortar. The obtained mixture is dried in the atmosphere at 100° C. to obtain a dry product. The obtained dry product is pulverized by the mortar.

An amount of water added into the mortar may be the amount to uniformly mix the dissolved and weighed Na₂CO₃.H₂O and H₂WO₄. Further, the drying time in the atmosphere at 100° C. may be the time required for the water to be evaporated, and about 12 hours is preferable.

As described above, in order to obtain the raw material in which each component is uniformly mixed at a molecular level, each raw material is preferably mixed in a solution. From this viewpoint, the tungsten compound containing sodium is preferably the one that can be dissolved into a solvent such as water or organic solvent, etc.

Specifically, tungstate containing sodium, chloride salt, nitrate, sulfate, oxalate, oxide, carbonate, or hydroxides, etc., can be given, but the tungsten compound is not limited thereto, and a solution state may be preferable.

Heat treatment in an inert gas atmosphere or a reducing gas atmosphere will be described next.

The heat treatment can be performed in either of the inert gas atmosphere and the reducing gas atmosphere.

A case of performing heat treatment in the inert gas atmosphere will be described first.

Argon or nitrogen, etc., can be used as the inert gas. A heat treatment temperature is preferably set to 600 to 700° C. Also, a retention time is preferably set to 1 to 3 hours. The composite tungsten oxide particles expressed by a general formula Na_{y}WO_{z} (satisfying 0.3≦y≦1.1, 2.2≦z≦3.0) which are subjected to heat treatment in an appropriate temperature range, have high transmittance of the light with a wavelength of 500 nm, and are capable of reducing the light transmittance with a wavelength range of 700 nm to 1500 nm.

If the heat treatment temperature is 600° C. or more, precipitation of a different phase such as Na₂W₄O₁₃ or Na₂W₂O₇ can be avoided. On the other hand, if the heat treatment temperature is 700° C. or less, precipitation of the different phase such as Na₂WO₄ can be avoided, and therefore the composite tungsten compound particles having an infrared absorption power can be obtained.

Also, if the retention time is 1 hour or more, the composite tungsten compound particles having the abovementioned infrared absorption power can be obtained, and if the retention time is 3 hours or less, fuel or materials required for the heat treatment is not wasted.

A case of performing heat treatment in the reducing gas atmosphere will be described next.

Although the reducing gas is not particularly limited, hydrogen is preferable. This is because the composite tungsten compound particles reduced by hydrogen shows an excellent near-infrared shielding characteristic.

When hydrogen is used as the reducing gas, hydrogen is preferably mixed in the inert gas such as argon or nitrogen, etc., by a volume ratio of 0.1 to 5.0%, and further preferably mixed therein in the volume ratio of 0.2 to 5.0%. If hydrogen is present in the volume ratio of 0.1% or more, reduction can be efficiently promoted.

The heat treatment temperature is preferably set to 100 to 1200° C., and the heating time is preferably maintained for 1 to 3 hours. The heat treatment temperature is further preferably set to 400 to 1200° C., and most preferably set to 600 to 700° C.

Also, if the heating time is 1 hour or more, the composite tungsten compound particles having the abovementioned infrared absorption power can be obtained, and if the heating time is 3 hours or less, the fuel or materials required for the heat treatment are not wasted.

The composite tungsten oxide particles expressed by a general formula Na_{y}WO_{z} (satisfying 0.3≦y≦1.1, 2.2≦z≦3.0) which are subjected to heat treatment in an appropriate temperature range, can be used as they are as the near-infrared shielding particles.

In addition, in order to improve the light fastness of the composite tungsten oxide particles subjected to the heat treatment, surface treatment may be applied to the surface of the obtained composite tungsten oxide particles, using a compound containing one kind or more elements selected from Si, Ti, Zr, and Al, and preferably using oxides of these elements.

A publicly-known surface treatment operation may be performed when the abovementioned surface treatment is performed, using an organic compound containing one kind or more elements selected from Si, Ti, Zr, and Al. For example, a sol-gel method may be used as follows: the composite tungsten oxide particles and an organosilicon compound are mixed, and after hydrolysis, the mixture is heated.

(3) Dispersant

There is no particular limit in the dispersant constituting the near-infrared shielding particles dispersion liquid of the present invention, and a general dispersant capable of dispersing the composite tungsten oxide particles can be used.

As an example, the dispersant having a group containing amine, a hydroxyl group, a carboxyl group, and an epoxy group as functional groups, can be given. This is because the following effect is obtained: these functional groups are adsorbed on the surface of the composite tungsten oxide particles, to prevent aggregation of the composite tungsten oxide particles, and uniformly disperse the composite tungsten oxide particles in the near-infrared shielding film.

As a specific preferable example of the dispersant, an acryl-styrene copolymer dispersant having the carboxyl group as a functional group, and an acrylic dispersant having a group containing amine as a functional group, can be given. However, the dispersant is not limited thereto.

(4) Organic solvent

An organic solvent used for the near-infrared shielding particles dispersion liquid of the present invention is not particularly limited, and is suitably selected depending on a coating method or a film formation condition.

For example, alcohol-based solvents such as methanol, ethanol, isopropanol, butanol, benzyl alcohol, and diacetone alcohol, ketone-based solvents such as acetone, methyl ethyl ketone (MEK), methyl isobutyl ketone (MIBK), cyclohexanone, and isophorone, etc., glycol derivatives such as propylene glycol methyl ether, propylene glycol ethyl ether, etc., formamide, N-methyl formamide, dimethyl formamide (DMF), dimethyl acetamide, dimethyl sulfoxide (DMSO), and N-methyl-2-pyrrolidone (NMP), etc., can be given. However, the organic solvent is not limited thereto.

(5) Method of producing the near-infrared shielding particles-containing dispersion liquid

Explanation is given for the step of obtaining the near-infrared shielding particles-containing dispersion liquid by adding the near-infrared shielding particles and the dispersant into the organic solvent.

A method of dispersing the composite tungsten oxide particles which are the near-infrared shielding particles into the organic solvent, can be arbitrarily selected, if the particles are uniformly dispersed in the organic solvent.

As an example, the composite tungsten oxide particles and the dispersant are mixed into the organic solvent at ratios of 5 to 15 pts.wt. of composite tungsten oxide particles, 5 to 15 pts.wt. of dispersant, and 70 to 90 pts.wt. of solvent, to obtain a mixture. Then, the composite tungsten oxide particles can be uniformly dispersed in the organic solvent by using an apparatus and a method such as a beads mill, a ball mill, a sand mill, or an ultrasonic wave dispersion, etc.

The composite tungsten oxide particles in a dispersion liquid are preferably dispersed, with an average particle diameter of 200 nm or less. The composite tungsten oxide particles are more preferably dispersed with an average particle diameter of 40 nm or less. This is because if the average particle diameter is 40 nm or less, a haze value is 2.0% or less at a visible light transmittance of 45% or more of an infrared shielding film after production, and this is more preferable.

Further, if the average particle diameter of the composite tungsten oxide particles in the dispersion liquid is 10 nm or more, a dispersion operation is technically easy.

[2] Near-Infrared Absorption Filter Containing the Near-Infrared Shielding Particles and a Method of Producing the Same

A near-infrared absorption filter containing the near-infrared shielding particles of the present invention is produced by adding the dispersion liquid containing the near-infrared shielding particles into a binder resin, at ratios of 40 to 60 pts.wt. of dispersion liquid and 40 to 60 pts.wt. of binder resin, to obtain a mixture, and suitably coating the surface of a base material with this mixture to form a coating film, then evaporating an organic solvent from this coating film, and curing the binder resin.

As a method of suitably coating the surface of the base material with the mixture, a method of uniformly coating the surface of the base material with a resin film (coating film) containing the near-infrared shielding particles, may be used. For example, spin coating, bar coating, gravure coating, spray coating, and dip coating, etc., can be given.

It is also preferable that the composite tungsten oxide particles are directly dispersed in the binder resin, and a resin sheet is produced therefrom.

Specifically, the composite tungsten oxide particles are added into a powder binder resin, and thereafter are heat-formed by an extruder, to thereby produce a resin sheet in which the near-infrared shielding particles are dispersed.

According to this structure, there is no necessity for evaporating the organic solvent when producing the resin sheet, and therefore this structure is environmentally and industrially preferable.

As the abovementioned binder resin, for example, UV-curable resin, thermosetting resin, electron beam-curable resin, cold-setting resin, or thermoplastic resin can be suitably selected according to a purpose of use. Specifically, polyethylene resin, polyvinyl chloride resin, polyvinylidene chloride resin, polyvinyl alcohol resin, polystyrene resin, polypropylene resin, ethylene-vinyl acetate copolymer, polyester resin, polyethylene terephthalate resin, fluorine resin, polycarbonate resin, acrylic resin, polyvinyl butyral resin, etc., can be given. These resins may be used alone or may be used in combination.

Further, it is also acceptable to use a metal alkoxide as a binder, instead of the abovementioned binder resin.

Alkoxide such as Si, Ti, Al, and Zr, etc., can be given as the metal alkoxide. Hydrolysis and condensation polymerization occur by heating, etc., in the binder using these metal alkoxides, thus making it possible to form an oxide film.

Further, a film or a board may be used as desired, as the abovementioned base material coated with the near-infrared shielding particles-containing dispersion liquid, and the shape is not limited. As a transparent base material, glass, PET resin, acrylic resin, urethane resin, polycarbonate resin, polyethylene resin, ethylene-vinyl acetate copolymer, vinyl chloride resin, fluorine resin, etc., can be used according to the purpose of use.

The produced near-infrared absorption filter of the present invention has a strong absorption characteristic to the light with a wavelength of 700 to 1500 nm in a near-infrared region to IR region, while having a high transmittance in the visible light region.

Specifically, the transmittance at the wavelength of 500 nm is preferably 35% or more, and further preferably 45% or more, and a maximum transmittance at the wavelength of 700 to 1500 nm is preferably 10% or less, in consideration of using the near-infrared absorption filter of the present invention as the near-infrared absorption filter in the imaging device such as CCD, etc.

Therefore, the near-infrared absorption filter of the present invention shows the maximum transmittance of 5% or less at the wavelength of 700 to 1500 nm, when the transmittance is 45% or more at the wavelength of 500 nm, and further shows the maximum transmittance of 2.5% or less at the wavelength of 700 to 1500 nm when the transmittance at the wavelength of 500 nm is 50% or more.

Also, since the composite tungsten oxide particles which are inorganic oxide substances are used as the near-infrared shielding particles, the near-infrared absorption filter of the present invention has an excellent light fastness, compared with the near-infrared absorption filter of a conventional technique in which an organic substance is used.

Further, as described above, the light fastness can be preferably more improved by applying surface treatment to the composite tungsten oxide particles of the present invention so as to be coated with a compound containing one kind or more elements selected from Ti, Zr, and Al, and preferably coated with oxides of these elements.

As a result, the near-infrared absorption filter can be suitably used for the imaging device.

### EXAMPLES

The present invention will be specifically described hereafter, with reference to examples. However, the present invention is not limited to the following examples.

Here, visible light transmittance and solar radiation transmittance of the heat ray shielding laminated transparent substrate in each example was measured using a spectrophotometer U-4000 manufactured by Hitachi Corporation.

Further, the haze value was measured using HR-200 by Murakami Color Research Laboratory Co. Ltd. based on JIS K 7105.

The average particle diameter of each particle was obtained by observing particles in a visual field using a transmission electron microscope (Hitachi: HF-2200), then measuring diameters of a plurality of particles in this visual field, and averaging the obtained values at the diameters of the plurality of particles.

### Example 1

H₂WO₄ 8.01 g and Na₂CO₃.H₂O 1.99 g, were weighed at a molar ratio of Na/W=1.00, which were then sufficiently mixed in an agate mortar, to obtain a mixed powder. The obtained mixed powder was heated under supply of 5% hydrogen gas, using a nitrogen gas as a carrier, which was then retained under the reducing atmosphere for 2 hours at a temperature of 650° C., to obtain the composite tungsten oxide particles which are the near-infrared shielding particles. The obtained composite tungsten oxide particles had a tetragonal crystal system at molar ratio of O/W=3.00.

Near-infrared shielding particles 10 mass %, dispersant having an amino-group as a functional group 10 mass % (amine value: 40 mL/g, decomposition temperature: 230° C.), and methyl isobutyl ketone (MIBK) 80 mass % as an organic solvent, were weighed. These materials were pulverized/dispersed for 7 hours by a paint shaker with 0.3 mmφZrO₂ beads put therein.

Here, the average particle diameter of each tungsten oxide particle was 10 nm in the near-infrared shielding particles-containing dispersion liquid. UV-curable resin was added into the near-infrared shielding particles-containing dispersion liquid at a ratio of the dispersion liquid/UV-curable resin (weight ratio)=1.00, to obtain a resin composition, and a glass substrate was coated with the resin composition by a bar coater. The coated glass substrate was dried at 70° C., and the organic solvent was removed, which was then irradiated with UV to cure the UV-curable resin, to thereby obtain a near-infrared absorption filter A of example 1 containing dispersed tungsten oxide particles.

Optical properties of the near-infrared absorption filter A were evaluated.

First, transmittance of a light was measured. The transmittance at a wavelength of 500 nm was 49.0%, and a maximum value of the light transmittance in a wavelength range of 700 nm to 1500 nm was 4.5%. Further, a haze value was 0.6%.

### Example 2

An infrared absorption filter B of example 2 was obtained similarly to example 1, excluding a point that H₂WO₄ 8.43 g and Na₂CO₃.H₂O 1.57 g, were weighed at a molar ratio of Na/W=0.75, which were the then sufficiently mixed in an agate mortar to obtain a mixed powder, and the mixed powder was heated under supply of 5 hydrogen gas using a nitrogen gas as a carrier, and retained under the reducing atmosphere for 2.5 hours at 650° C.

The obtained composite tungsten oxide particles had a tetragonal crystal system at a molar ratio of O/W=2.85, and the average particle diameter was 40 nm.

Optical properties of the near-infrared absorption filter B were evaluated.

First, transmittance of a light was measured. The transmittance at a wavelength of 500 nm was 50.4%, and a maximum value of the light transmittance in a wavelength range of 700 nm to 1500 nm was 2.3%. Further, the haze value was 0.5%.

### Example 3

An infrared absorption filter C of example 3 was obtained similarly to example 1, excluding a point that H₂WO₄ 8.43 g and Na₂CO₃.H₂O 1.46 g, were weighed at a molar ratio of Na/W=0.70, which were then sufficiently mixed in an agate mortar to obtain a mixed powder, and the mixed powder was heated under supply of 5% hydrogen gas using a nitrogen gas as a carrier, and retained under the reducing atmosphere for 2.5 hours a 650° C.

The obtained composite tungsten oxide particles had a tetragonal crystal system at a molar ratio of O/W=2.80, and the average particle diameter was 200 nm.

Optical properties of the near-infrared absorption filter C were evaluated.

First, transmittance of a light was measured. The transmittance at a wavelength of 500 nm was 47.5%, and the maximum value of the light transmittance in a wavelength range of 700 nm to 1500 nm was 3.5%. Further, the haze value was 0.6%.

### Example 4

An infrared absorption filter D of example 4 was obtained similarly to example 1, excluding a point that H₂WO₄ 8.90 g and Na₂CO₃H₂O 1.10 g, were weighed at a molar ratio of Na/W=0.50, which were then sufficiently mixed in an agate mortar, to obtain a mixed powder. The obtained mixed powder was heated under supply of 5% hydrogen gas, using a nitrogen gas as a carrier, which was then retained under the reducing atmosphere for 2.5 hours at a temperature of 650° C.

The obtained composite tungsten oxide particles had a tetragonal crystal system at a molar ratio of O/W=2.80, and the average particle diameter was 30 nm.

Optical properties of the obtained near-infrared absorption filter D were evaluated.

First, transmittance of a light was measured. The transmittance at a wavelength of 500 nm was 45.9%, and the maximum value of the light transmittance in a wavelength range of 700 nm to 1500 nm was 6.5%. Further, the haze value was 0.5%.

### Example 5

An infrared absorption filter E of example 5 was obtained similarly to example 1, excluding a point that H₂WO₄ 9.24 g and Na₂CO₃.H₂O 0.76 q, were weighed at a molar ratio of Na/W=0.33, which were then sufficiently mixed in an agate mortar, to obtain a mixed powder. The obtained mixed powder was heated under supply of 5% hydrogen gas, using a nitrogen gas as a carrier, which was then retained under the reducing atmosphere for 3 hours at a temperature of 650° C.

The molar ratio (O/W) of the obtained composite tungsten oxide particles was 2.20, and the average particle diameter was 40 nm.

Optical properties of the near-infrared absorption filter E were evaluated.

First, transmittance of a light was measured. The transmittance at a wavelength of 500 nm was 36.3%, and the maximum value of the light transmittance in a wavelength range of 700 nm to 1500 nm was 4.9%. Further, the haze value was 0.6%.

### Example 6

An infrared absorption filter F of example 6 was obtained similarly to example 1, excluding a point that H₂WO₄ 9.24 g and Na₂CO₃—H₂O 2.52 g, were weighed at a molar ratio of Na/W=1.10, which were then sufficiently mixed in an agate mortar, to obtain a mixed powder. The obtained mixed powder was heated under supply of 5% hydrogen gas, using a nitrogen gas as a carrier, which was then retained under the reducing atmosphere for 2.75 hours at a temperature of 650° C.

The molar ratio (O/W) of the obtained composite tungsten oxide particles was 2.50, and the average particle diameter was 40 nm.

Optical properties of the obtained near-infrared absorption filter F were evaluated.

First, transmittance of a light was measured. The transmittance at a wavelength of 500 nm was 42.3%, and the maximum value of the light transmittance in a wavelength range of 700 nm to 1500 nm was 4.7%. Further, the haze value was 0.6%.

### Comparative Example 1

An infrared absorption filter G of comparative example 1 was obtained similarly to example 1, excluding a point that H₂WO₄ 9.53 g and Na₂CO₃.H₂O 0.47 g, were weighed at a molar ratio of Na/W=0.21, which were then sufficiently mixed in an agate mortar, to obtain a mixed powder. The obtained mixed powder was heated under supply of 5% hydrogen gas, using a nitrogen gas as a carrier, which was then retained under the reducing atmosphere for 3 hours a temperature of 700° C.

The molar ratio (O/W) of the obtained composite tungsten oxide particles was 2.10, and the average particle diameter was 40 nm.

Optical properties of the near-infrared absorption filter G were evaluated.

First, transmittance of a light was measured. The transmittance at a wavelength of 500 nm was 50.5%, and the maximum value of the light transmittance in a wavelength range of 700 nm to 1500 nm was 25.1%. Further, the haze value was 0.6%.

### Comparative Example 2

An infrared absorption filter H of comparative example 2 was obtained similarly to example 1, excluding a point that H₂WO₄ 6.68 g and Na₂CO₃.H₂O 3.31 g, were weighed at a molar ratio of Na/W=2.00, which were then sufficiently mixed in an agate mortar, to obtain a mixed powder. The obtained mixed powder was heated under supply of 5% hydrogen gas, sing a nitrogen gas as a carrier, which was then retained under the reducing atmosphere for 2 hours at a temperature of 600° C.

The molar ratio (O/W) of the obtained composite tungsten oxide particles was 10, and the average particle diameter was 40 nm.

Optical properties of the near-infrared absorption filter H were evaluated.

First, transmittance of a light was measured. The transmittance at a wavelength of 500 nm was 52.2%, and the maximum value of the light transmittance in a wavelength range of 700 nm to 1500 nm was 30.6%. Further, the haze value was 0.6%.

### Comparative Example 3

An infrared absorption filter I of comparative example 3 was obtained similarly to example 1, excluding a point that Cs_{0.33}WO₃ was used as composite tungsten oxide particles. The average particle diameter was 50 nm.

Optical properties of the near-infrared absorption filter I were evaluated.

First, transmittance of a light was measured. The transmittance at a wavelength of 500 nm was 54.8%, and the maximum value of the light transmittance in a wavelength range of 700 nm to 1500 nm was 23.0%. Further, the haze value was 0.4%.

TABLE 1

| | | | | | Optical properties of the near-infrared | |
|---|---|---|---|---|---|---|
| | | | | | absorption filter | |
| | Near-infrared shielding particles | | | | Maximum value of transmittance | |
| | | | Particle | | of light in wavelength range of | Transmittance at |
| | Na/W | O/W | diameter | | 700 to 1500 nm | wavelength of 500 nm |
| | (Molar ratio) | (Molar ratio) | (nm) | | (%) | (%) |
| Example 1 | 1.00 | 3.00 | 10 | Filter A | 4.5 | 49.0 |
| Example 2 | 0.75 | 2.85 | 40 | Filter B | 2.3 | 50.4 |
| Example 3 | 0.70 | 2.80 | 200 | Filter C | 3.5 | 47.5 |
| Example 4 | 0.50 | 2.80 | 30 | Filter D | 6.5 | 45.9 |
| Example 5 | 0.33 | 2.20 | 40 | Filter E | 4.9 | 36.3 |
| Example 6 | 1.10 | 2.50 | 40 | Filter F | 4.7 | 42.3 |
| Comparative | 0.21 | 2.10 | 40 | Filter G | 25.1 | 50.5 |
| example 1 | | | | | | |
| Comparative | 2.00 | 3.10 | 40 | Filter H | 30.6 | 52.2 |
| example 2 | | | | | | |
| Comparative | — | 3.00 | 50 | Filter I | 23.0 | 54.8 |
| example 3 | | | | | | |

1-9. (canceled)

10. A near-infrared absorption filter, comprising tungsten oxide composite particles expressed by a general formula Na_{y}WO_{z} (satisfying 0.3≦y≦1.1, 2.2≦z≦3.0), as near-infrared shielding particles.

11. A near-infrared absorption filter, comprising tungsten oxide composite particles expressed by a general formula Na_{y}WO_{z} (satisfying 0.70≦y≦1.00, 2.20≦z≦3.00), as near-infrared shielding particles.

12. The near-infrared absorption filter according to claim 10, wherein an average particle diameter of the near-infrared shielding particles is 10 nm or more and 200 nm or less.

13. The near-infrared absorption filter according to claim 10, wherein a crystal system of the near-infrared shielding particles is cubic.

14. A near-infrared absorption filter, made of a binder resin on the transparent substrate, with the near-infrared shielding particles of claim 10 dispersed in the binder resin, wherein any one of the UV curing resin, thermosetting resin, electron beam-curable resin, cold-setting resin, and thermoplastic resin is used as the binder resin.

15. A near-infrared absorption filter with a metal alkoxide formed on the transparent substrate, wherein the near-infrared shielding particles of claim 10 are dispersed.

16. The near-infrared absorption filter according to claim 10, wherein a maximum value of the light transmittance in a wavelength range of 700 nm to 1500 nm is 5.0% or less, when the light transmittance with a wavelength of 500 nm is 45% or more.

17. The near-infrared absorption filter according to claim 10, wherein a maximum value of the light transmittance in a wavelength range of 700 nm to 1500 nm is 2.5% or less, when the light transmittance with a wavelength of 500 nm is 50% or more.

18. An imaging device, wherein the near-infrared absorption filter of claim 10 is used.
